(19) United States
(12) Patent Application Publication
(10) Pub. No.: US 2019/0315190 A1
(43) Pub. Date: Oct. 17, 2019

(54) AIR DISTRIBUTION CHUTE MOUNTING SYSTEM

(71) Applicant: Signode Industrial Group, LLC, Glenview, IL (US)

(72) Inventor: Allan Charles Draheim, Lagrange, GA (US)

(21) Appl. No.: 16/255,151

(22) Filed: Jan. 23, 2019

Related U.S. Application Data
(60) Provisional application No. 62/656,011, filed on Apr. 11, 2018.

(51) Int. Cl. B60H 1/00; B60P 3/20

(52) U.S. Cl. CPC B60H 1/00564; B60Y 2200/147; B60Y 2200/148; B60P 3/20

(57) ABSTRACT

Various embodiments of the present disclosure provide an improved air distribution chute mounting system that can adjust to refrigeration units of different sizes and that can be used to secure the front end of the air distribution chute near the ceiling of the refrigeration trailer during cargo loading.

### PRIORITY

This application claims priority to and the benefit of U.S. Provisional Patent Application No. 62/656,011, filed Apr. 11, 2018, the entire contents of which are incorporated herein by reference.

### FIELD

The present disclosure generally relates to an improved system for mounting an air distribution chute within a refrigeration trailer. More particularly, the present disclosure relates to an improved air distribution chute mounting system that can adjust to refrigeration units of different sizes and that can be used to secure the front end of the air distribution chute near the ceiling of the refrigeration trailer during cargo loading.

### BACKGROUND

Distributors use temperature-controlled refrigeration trailers to transport cargo (such as food products) that must be maintained within a specific temperature range. Each trailer includes a refrigeration unit at the front of the trailer that controls the temperature in the trailer by cooling the air. The refrigeration unit includes an air intake near the floor of the trailer and an air outlet near the ceiling of the trailer. In operation, the refrigeration unit draws air into the air intake, cools the air, and expels the cooled air out of the air outlet and back into the trailer. A return-air bulkhead is typically attached to the front wall of the trailer and positioned in front of the air intake of the refrigeration unit to optimize airflow into the air intake and to protect the air intake from damage (e.g., from contact with forklift tines or cargo).

A flexible air distribution chute is typically mounted to the trailer such that the chute is fluidly connected to the air outlet of the refrigeration unit. This enables the chute to distribute the cooled air to the rear of the trailer. Certain known systems for mounting air distribution chutes to trailers do not take into account the fact that refrigeration units differ in size. This can cause gaps between the air distribution chute and the air outlet of the refrigeration unit that cooled air can leak through. This reduces the effectiveness of the refrigeration unit and the air distribution chute since less cooled air reaches the rear of the trailer. Also, forklift operators sometimes contact the air distribution chute (which hangs below the ceiling of the trailer) with cargo as they load the cargo into the trailer. This can tear the air distribution chute and cause it to leak, rendering the chute less effective or even inoperable.

### SUMMARY

Various embodiments of the present disclosure provide an improved air distribution chute mounting system that can adjust to refrigeration units of different sizes and that can be used to secure the front end of the air distribution chute near the ceiling of the refrigeration trailer during cargo loading.

In various embodiments, the air distribution chute mounting system of the present disclosure includes a mounting bracket, a guide rod mountable to the mounting bracket, a chute mounting rod mountable to the guide rod such that the chute mounting rod is movable relative to the guide rod between a lower position and an upper position, and a lifting member connectable to the chute mounting rod and operable to move the chute mounting rod from the lower position to the upper position.

In various embodiments, the present disclosure also provides a method for mounting an air distribution chute to a trailer having a front wall, a ceiling, and a refrigeration unit partially extending from the front wall into the trailer, wherein the method includes: mounting a portion of the air distribution chute to the trailer; mounting a first mounting bracket to the front wall on a first side of the refrigeration unit; mounting a second mounting bracket to the front wall on a second side of the refrigeration unit opposite the first side; mounting a first guide rod to the first mounting bracket and a second guide rod to the second mounting bracket; mounting a forward end of the air distribution chute to a chute mounting rod; mounting the chute mounting rod to the first and second guide rods such that the chute mounting rod is movable relative to the first and second guide rods between a lower position in which the air distribution chute is in fluid communication with an air outlet of the refrigeration unit and an upper position in which the chute mounting rod is closer to the ceiling of the trailer than when in the lower position; operably connecting first and second lifting members to the chute mounting rod; and moving the chute mounting rod from the lower position to the upper position via the first and second lifting members.

### BRIEF DESCRIPTION OF THE FIGURES

FIG. 1 is a fragmentary diagrammatic perspective view of part of an example refrigeration trailer including an example refrigeration unit.

FIG. 2 is an exploded perspective view of one example embodiment of the air distribution chute mounting system of the present disclosure.

FIG. 3A is a perspective view of one of the mounting brackets of the air distribution chute mounting system of FIG. 2.

FIG. 3B is a top plan view of the mounting bracket of FIG. 3A.

FIG. 4A is a fragmentary front elevational view of the front wall of the refrigeration trailer of FIG. 1 with the air distribution chute mounting system of FIG. 2 mounted thereto and the chute mounting rod of the air distribution chute mounting system in its lower position.

FIG. 4B is similar to FIG. 4A, but illustrates the chute mounting rod in its upper position.

FIG. 5A is a fragmentary right-side elevational view of the front and left side walls of the refrigeration trailer of FIG. 1 with the air distribution system chute mounting system of FIG. 2 mounted to the front wall. An air distribution chute is mounted to the ceiling of the refrigeration trailer and to the chute mounting rod of the air distribution chute mounting system, and the rod in its lower position.

FIG. 5B is similar to FIG. 5A, but illustrates the chute mounting rod in its upper position.

The figures are not to scale and certain dimensions are exaggerated for clarity.

### DETAILED DESCRIPTION

While the systems, devices, and methods described herein may be embodied in various forms, the drawings show and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, attached, etc., are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

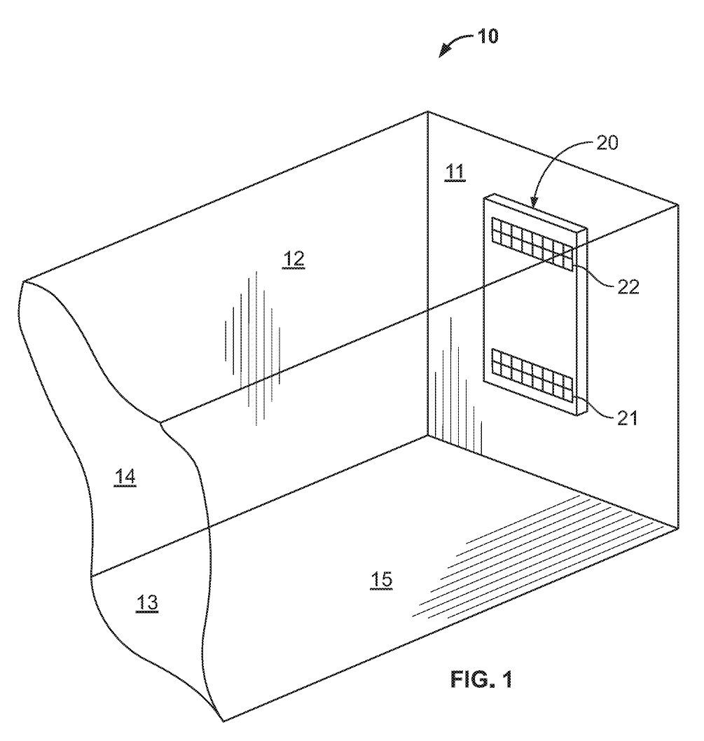

Turning now to the figures, FIG. 1 illustrates the interior of a refrigeration trailer 10 (sometimes referred to as the “trailer 10” for brevity) including a front wall 11, a ceiling 12, a floor 13 opposite the ceiling 12, a left side wall 14, and a right side wall 15 opposite the left side wall 14. The refrigeration trailer 10 includes a rear wall (not shown) opposite the front wall 11 that includes doors that provide access to the interior of the trailer 10. A suitable refrigeration unit 20 is mounted to the front wall 11 of the refrigeration trailer 10 and includes an air intake 21 and an air outlet 22. The refrigeration unit 20 is configured to draw air from the refrigeration trailer 10 into the air intake 21, cool the air, and expel the cooled air through the air outlet 22 back into the refrigeration trailer 10 (via a flexible air distribution chute). Although not shown here, a return-air bulkhead may be attached to the front wall 11 of the refrigeration trailer 10 so the return-air bulkhead covers the air intake 21. The return-air bulkhead optimizes air flow into the air intake 21 and protects the air intake 21 from damage. The return-air bulkhead may be any suitable return-air bulkhead, such as any of those described in U.S. Pat. Nos. 6,945,865; 8,298,056; and U.S. Patent Application Publication No. 2017/0282678, the entire contents of each of which are incorporated herein by reference.

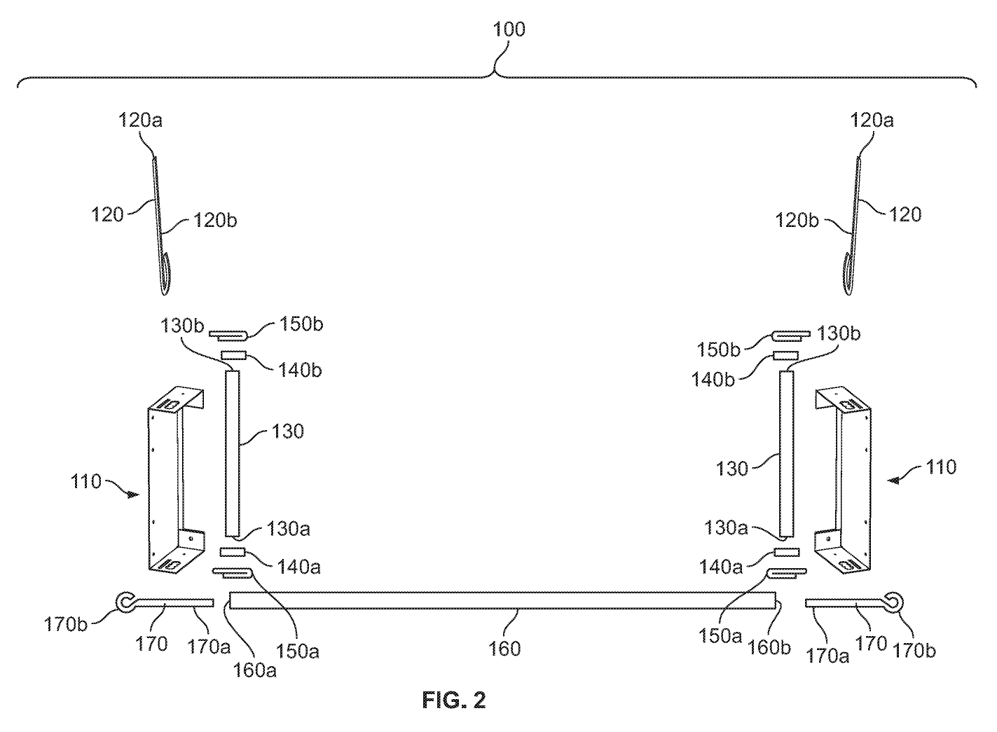

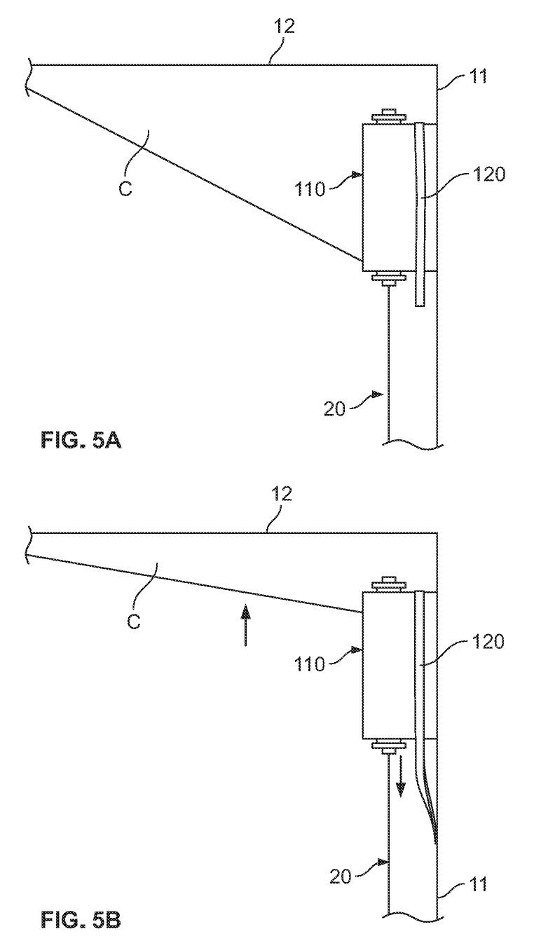

FIG. 2 illustrates one example embodiment of the air distribution chute mounting system 100 of the present disclosure (sometimes referred to as the “mounting system 100” for brevity). As described in detail below with respect to FIGS. 5A and 5B, a forward end of a flexible air distribution chute C (sometimes referred to as the “chute C” for brevity) is configured to be mounted to the chute mounting system 100 such that the forward end can move between: (1) a lower position (FIG. 5A) in which the chute C is in fluid communication with the air outlet 22 of the refrigeration unit 20 so the chute C can distribute cooled air expelled from the air outlet 22 to the rear of the trailer 10; and (2) an upper position (FIG. 5B) in which the forward end of the chute C is positioned at or near the ceiling 12 of the trailer 10 to reduce the likelihood of damage during cargo loading.

As best shown in FIG. 2, the chute mounting system 100 includes left and right mounting brackets 110, left and right lifting members 120, left and right guide rods 130, left and right pairs of washers 140a and 140b, left and right pairs of retaining elements 150a and 150b, a chute mounting rod 160, and left and right connecting members 170. In this example embodiment, the mounting brackets are identical, the lifting members are identical, the guide rods are identical, the washers are identical, the retaining elements are identical, and the connecting members are identical. These components may differ in other embodiments.

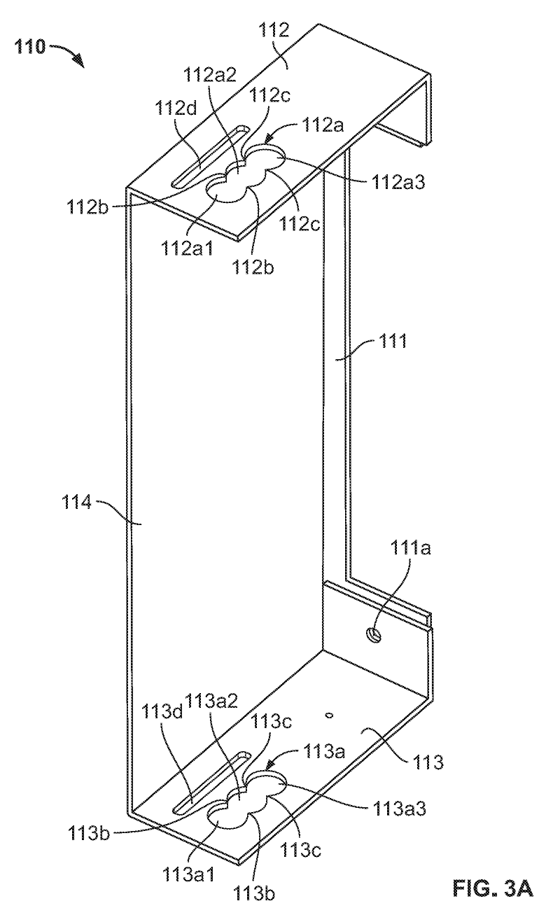

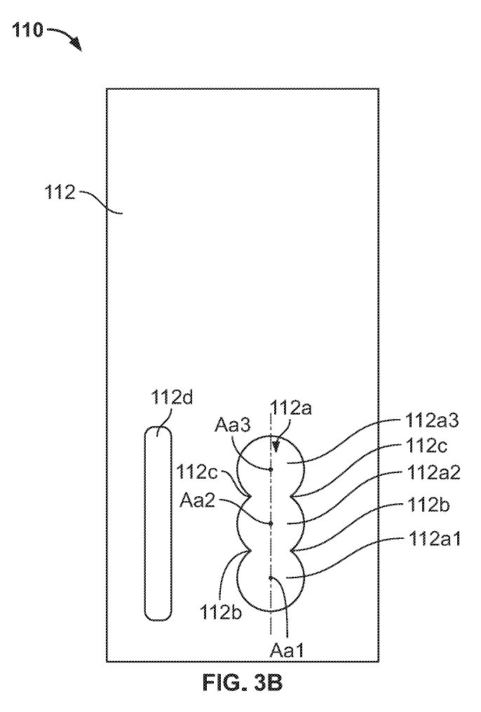

FIGS. 3A and 3B illustrate one of the mounting brackets 110, which includes a body having a planar, C-shaped front wall 111; a planar, rectangular top wall 112; a planar, rectangular bottom wall 113; and a planar, rectangular side wall 114 (the walls may take any suitable shape(s) in other embodiments). The front wall 111 is connected to the side wall 114 and is connected to and extends between the top and bottom wall 112 and 113. The side wall 114 is connected to and extends between the top and bottom walls 112 and 113. In this example embodiment, the walls that form the body of the mounting bracket 110 are integrally formed such that the body is formed from a single bent or molded piece of material. In other embodiments, some or all of the walls are not integrally formed with one another such that the body is formed from multiple pieces of material welded, fastened, or otherwise attached to one another.

The front wall 111 defines one or more fastener-receiving openings 111a therethrough. Each fastener-receiving opening is sized to receive a fastener and to enable the fastener to extend therethrough to mount the mounting bracket 110 to the front wall 11 of the refrigeration trailer 10.

The top wall 112 defines an opening 112a therethrough comprised of a first generally circular guide rod receiving opening 112a1, a second generally circular guide rod receiving opening 112a2, and a third generally circular guide rod receiving opening 112a3. The top wall 112 includes opposing projections 112b that extend into opposing sides of the opening 112a to separate and partially define the shapes of the first and second guide rod receiving openings 112a1 and 112a2. The top wall 112 also includes opposing projections 112c that extend into opposing sides of the opening 112b to separate and partially define the shapes of the second and third guide rod receiving openings 112a2 and 112a3.

Each guide rod receiving opening 112a1, 112a2, and 112a3 is sized and shaped to receive the guide rod 130 and enable the guide rod 130 to extend therethrough. The projections 112b and 112c are sized and shaped such that: (1) when the guide rod 130 is received in the first guide rod receiving opening 112a1, the guide rod 130 cannot laterally move (i.e., cannot move perpendicularly relative to its longitudinal axis) from the first guide rod receiving opening 112a1 to the second or third guide rod receiving openings 112a2 and 112a3; (2) when the guide rod 130 is received in the second guide rod receiving opening 112a2, the guide rod 130 cannot laterally move from the second guide rod receiving opening 112a2 to the first or third guide rod receiving openings 112a1 or 112a3; and (3) when the guide rod 130 is received in the third guide rod receiving opening 112a3, the guide rod 130 cannot laterally move from the third guide rod receiving opening 112a3 to the first or second guide rod receiving openings 112a1 or 112a2. Thus, once the guide rod 130 is received in one of the guide rod receiving openings 112a1, 112a2, and 112a3, the projections 112b and/or 112c prevent lateral movement of the guide rod to another one of the guide rod receiving openings. To move the guide rod 130 to another guide rod receiving opening, the operator must first remove the guide rod from the current guide rod receiving opening.

The top wall 112 also defines a lifting member receiving opening 112d (here, a slot, though the lifting member receiving opening may take any suitable shape) therethrough that is positioned between the opening 112a and the side wall 114 (though the lifting member receiving opening may be positioned elsewhere in other embodiments). The lifting member receiving opening 112d is sized and shaped to receive the lifting member 120 and enable the lifting member 120 to extend therethrough. In various embodiments, the top wall does not define a lifting member receiving opening. In certain embodiments, the side wall 114 defines a lifting member receiving opening.

The bottom wall 113 defines an opening 113a therethrough comprised of a first generally circular guide rod receiving opening 113a1, a second generally circular guide rod receiving opening 113a2, and a third generally circular guide rod receiving opening 113a3. The bottom wall 113 includes opposing projections 113b that extend into opposing sides of the opening 113a to separate and partially define the shapes of the first and second guide rod receiving openings 113a1 and 113a2. The bottom wall 113 also includes opposing projections 113c that extend into opposing sides of the opening 113b to separate and partially define the shapes of the second and third guide rod receiving openings 113a2 and 113a3.

Each guide rod receiving opening 113a1, 113a2, and 113a3 is sized and shaped to receive the guide rod 130 and enable the guide rod 130 to extend therethrough. The projections 113b and 113c are sized and shaped such that: (1) when the guide rod 130 is received in the first guide rod receiving opening 113a1, the guide rod 130 cannot laterally move from the first guide rod receiving opening 113a1 to the second or third guide rod receiving openings 113a2 and 113a3; (2) when the guide rod 130 is received in the second guide rod receiving opening 113a2, the guide rod 130 cannot laterally move from the second guide rod receiving opening 113a2 to the first or third guide rod receiving openings 113a1 or 113a3; and (3) when the guide rod 130 is received in the third guide rod receiving opening 113a3, the guide rod 130 cannot laterally move from the third guide rod receiving opening 113a3 to the first or second guide rod receiving openings 113a1 or 113a2. Thus, once the guide rod 130 is received in one of the guide rod receiving openings 113a1, 113a2, and 113a3, the projections 113b and/or 113c prevent lateral movement of the guide rod to another one of the guide rod receiving openings. To move the guide rod 130 to another guide rod receiving opening, the operator must first remove the guide rod from the current guide rod receiving opening.

The bottom wall 113 also defines a lifting member receiving opening 113d (here, a slot, though the lifting member receiving opening may take any suitable shape) therethrough that is positioned between the opening 113a and the side wall 114 (though the lifting member receiving opening may be positioned elsewhere in other embodiments). The lifting member receiving opening 113d is sized and shaped to receive the lifting member 120 and enable the lifting member 120 to extend therethrough. In certain embodiments, the bottom wall does not define a lifting member receiving opening.

As best shown in FIG. 3B, the openings 112a and 113a are similarly (and in some cases identically) shaped and sized and are generally vertically aligned with one another. More specifically, the first guide rod receiving openings 112a1 and 113a1 are vertically aligned along an axis Aₐ₁ and form a first pair of guide rod receiving openings, the second guide rod receiving openings 112a2 and 113a2 are vertically aligned along an axis Aₐ₂ and form a second pair of guide rod receiving openings, and the third guide rod receiving openings 112a3 and 113a3 are vertically aligned along an axis Aₐ₃ and form a third pair of guide rod receiving openings. The axes Aₐ₁, Aₐ₂, and Aₐ₃ are generally: coplanar, parallel to the side wall 114 and the front wall 111, and perpendicular to the top and bottom walls 112 and 113. The lifting member receiving openings 112d and 113d are similarly (and in some cases identically) shaped and sized and are generally vertically aligned with one another.

As best shown in FIG. 2, each lifting member 120 includes a body having a trailer mounting end 120a and a connecting member attachment end 120b. The trailer mounting end 120a includes a trailer mounting element (not shown)—such as a grommet, a loop, a hook-and-loop fastener, adhesive, a hook, a snap, or a bar—configured to attach to the front wall, the side wall, or another portion of the refrigeration trailer (as described below in conjunction with FIGS. 5A and 5B). The connecting member attachment end 120b includes a connecting member attachment element—such as a loop, such as a grommet, a hook-and-loop patch, an adhesive patch, a hook, a snap, or a bar—configured to operably connect the connecting member attachment end to one of the connecting members 170 such that the lifting member 120 can move that connecting member. In this example embodiment, the lifting members 120 are nylon straps, the trailer mounting elements at the trailer mounting ends 120a are metal snaps, and the connecting member attachment elements at the connecting member attachment ends 120b are loops formed from the nylon straps. In other embodiments, the lifting member may be any suitable flexible member (such as a rope, a chain, or a wire) or any suitable rigid member (such as a rod).

Each guide rod 130 has a cylindrical (or any other suitably shaped) body with a lower end 130a and an opposing upper end 130b. The body is sized and shaped to be received in the guide rod receiving openings 112a1, 113a1, 112a2, 113a2, 112a3, and 113a3. The washers 140a and 140b are sized to receive the guide rods 130. The retaining elements 150a and 150b are cotter pins, retaining clips, or other suitable elements configured to attach to the guide rods 130 near their lower and upper ends 130a and 130b to retain the guide rods 130 in place after being mounted to the mounting brackets 110, as described below.

The chute mounting rod 160 includes a cylindrical weighted body having opposing ends 160a and 160b. A longitudinal bore (not shown) is defined in and extends inward from each end 160a and 160b of the body. The bores are sized and shaped to slidably receive respective connecting members 170, as described below.

The connecting members 170 each include a body having a shank end 170a and a guide rod attachment end 170b. The shank end 170a is sized and shaped to be slidably received in a bore of the chute mounting rod 160 such that the guide rod 170 can slide relative to the chute mounting rod 160 along the longitudinal axis of the chute mounting rod 160. The guide rod attachment end 170b is configured to be slidably mounted to the guide rod 130 such that the connecting member 170 can slide along the guide rod 130. In this example embodiment, the guide rod attachment end 170b forms an eyelet sized to receive the guide rod 130 and enable the guide rod 130 to pass therethrough.

The process of mounting the chute mounting system 100 to the front wall 11 of the refrigeration trailer 10 and of mounting the chute C to the chute mounting system 100 is now described. An operator mounts the left mounting bracket 110 to the front wall 11 on the left side of the refrigeration unit 20 by securing fasteners through the fastener-receiving openings 111a of the front wall 111 of the left mounting bracket 110 and into the front wall 11. The operator does so such that the top and bottom walls 112 and 113 of the left mounting bracket 110 are generally parallel to the ceiling 12 and the floor 13 of the refrigeration trailer 10 and such that the side wall 114 of the left mounting bracket 110 is generally parallel to the left and right side walls 14 and 15 of the refrigeration trailer 10. The operator repeats this process with the right mounting bracket 110 on the right side of the refrigeration unit 20.

The operator then mounts the left lifting member 120 to the guide rod attachment end 170b of the left connecting member 170. In this example embodiment, the operator does so by threading the part of the guide rod attachment end 170b through the loop at the connecting member attachment end 120b of the left lifting member 120. The operator threads the trailer mounting end 120a through the lifting member receiving slot 112d in the top wall 112 of the left mounting bracket 110. The operator repeats this process with the right lifting member 120, the right connecting member 170, and the right mounting bracket 110.

The operator then determines which pair of guide rod mounting openings to use based on how far the refrigeration unit 20 extends from the front wall 11 of the refrigeration trailer 10 such that, after installation, gaps between the air distribution chute C and the front wall 11 of the refrigeration trailer 10 are minimized. In this example embodiment, the operator chooses the first pair of guide rod mounting openings 112a1 and 113a1.

The operator inserts the left guide rod 130 through the first guide rod receiving opening 113a1 in the bottom wall 113 of the left mounting bracket 110, through the eyelet at the guide rod attachment end 170b of the left connecting member 170, and through the first guide rod receiving opening 112a1 in the top wall 112 of the left mounting bracket 110 such that the lower and upper ends 130a and 130b of the left guide rod 130 respectively extend from the bottom and top surfaces 113 and 112 of the left mounting bracket 110. The operator installs a washer 140 and a retaining element 150 at each end of the left guide rod 130 to retain the left guide rod 130 in place relative to the left mounting bracket 130. This also retains the left connecting member 170 on the left guide rod 130 and constrains the left connecting member 170 between the top and bottom walls 112 and 113 of the left mounting bracket 110.

The operator inserts the chute mounting rod 160 into a tube (or a series of tubes) formed in a lower portion of the forward end (not shown) of the chute C. The operator inserts the shank ends 170a of the left and right connecting members 170 into the respective bores at the left and right ends 160a and 160b of the chute mounting rod 160. The operator then repeats the above-described process to attach the right guide rod 130 and the right connecting member 170 to the right mounting bracket 110.

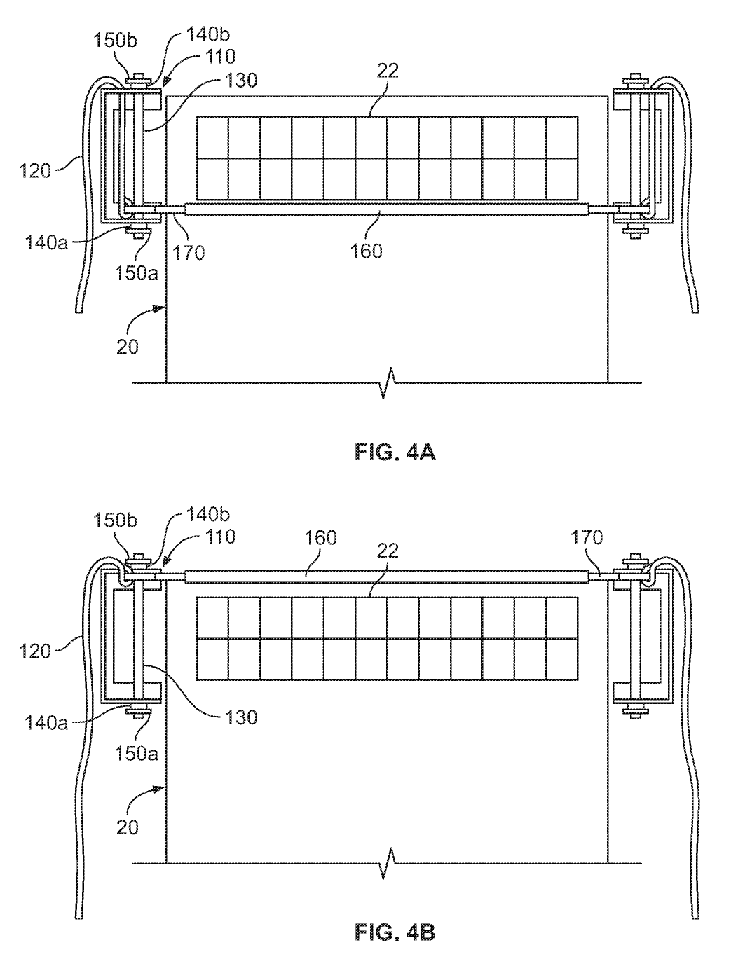

As best shown in FIGS. 4A and 5A, the weight of the chute mounting rod 160 forces the chute mounting rod 160 into a default, lower position in which the air distribution chute C is in fluid communication with the air outlet 22 of the refrigeration unit 20 so the air distribution chute C can distribute cooled air expelled from the air outlet 22.

The chute mounting rod 160 (and the attached connecting members 170) is movable relative to the mounting brackets 110, the guide rods 130, the refrigeration trailer 10, and the refrigeration unit 20 from the lower position to an upper position (FIGS. 4B and 5B) in which the forward end of the air distribution chute C is stowed at or near the ceiling 12 of the refrigeration trailer to reduce the likelihood of damage during cargo loading. Since the connecting members 170 are mounted to the guide rods 130 such that they are freely slidable relative to the guide rods 130, the chute mounting rod 160 can freely move upward when the chute mounting rod or the forward portion of the air distribution chute C is contacted from below, such as by a palletized load during cargo loading. This reduces the likelihood of the cargo damaging the air distribution chute during cargo loading.

Further, since the lifting members 120 are connected to the connecting members 170 (which are in turn connected to the chute mounting rod 160), an operator can pull on the lifting members 120 to manually move the chute mounting rod 160 from the lower position to the upper position (and vice-versa). The operator can removably attach the trailer mounting elements at the trailer mounting ends 120a of the lifting members 120 to the trailer (such as to counterpart connecting elements on the front wall 11 of the trailer) to retain the chute mounting rod 160 in the upper position for an extended period of time, such as during cargo loading. Once loading is complete, the operator can detach the trailer mounting elements from the trailer and enable the chute mounting rod 160 to return (via gravity) to its lower position.

The fact that the shank ends 170a of the connecting members 170 are slidably received in the bores at the respective ends 160a and 160b of the chute mounting rod 160 is also beneficial because one end of the chute mounting rod 160 can move upwardly (or downwardly) relative to the other end without causing the chute mounting rod to bind. For instance, an operator can first use the left lifting member 120 to lift and hold the left end 160a of the chute mounting rod 160 in the upper position. As the operator does so, part of the shank end 170a of the left connecting member 170 slides out of the bore in the left end 160a of the chute mounting rod 160 to compensate for the uneven elevations at the ends of the chute mounting rod 160. The operator then uses the right lifting member 120 to lift and hold the right end 160b of the chute mounting rod 160 in the upper position. As the operator does so, the portion of the shank end 170a of the left connecting member 170 exposed when the left end 160a was lifted slides back into the bore in the left end 160a.

The present disclosure contemplates that any features of the different example embodiments above may be combined together. Various changes and modifications to the presently preferred embodiments described herein will be apparent to those skilled in the art. These changes and modifications can be made without departing from the spirit and scope of the present subject matter and without diminishing its intended advantages. It is intended that such changes and modifications be covered by the appended claims.

1. An air distribution chute mounting system comprising:
a mounting bracket;
a guide rod mountable to the mounting bracket;
a chute mounting rod mountable to the guide rod such that the chute mounting rod is movable relative to the guide rod between a lower position and an upper position; and
a lifting member connectable to the chute mounting rod and operable to move the chute mounting rod from the lower position to the upper position.

2. The air distribution chute mounting system of claim 1, wherein the mounting bracket includes a body having a top wall and a bottom wall, wherein the top wall and the bottom wall each define an opening therethrough that is sized to receive the guide rod to enable the guide rod to be mounted to the mounting bracket.

3. The air distribution chute mounting system of claim 2, wherein the openings defined in the top and bottom walls each comprise a first guide rod receiving opening and a second guide rod receiving opening, wherein each guide rod receiving opening is sized to receive the guide rod to enable the guide rod to be mounted to the mounting bracket.

4. The air distribution chute mounting system of claim 3, wherein the top and bottom walls each include one or more projections that extend into the respective openings to separate and partially define the shapes of the first and second guide rod receiving openings.

5. The air distribution chute mounting system of claim 4, wherein the projections are sized and shaped such that, when the guide rod is received in one of the first guide rod receiving openings, the projections prevent lateral movement of the guide rod from that first guide rod receiving opening to one of the second guide rod receiving openings.

6. The air distribution chute mounting system of claim 3, wherein the first guide rod receiving openings are aligned along a first axis and the second guide rod receiving openings are aligned along a second axis.

7. The air distribution chute mounting system of claim 6, wherein the first and second axes are coplanar.

8. The air distribution chute mounting system of claim 7, wherein the first and second axes are perpendicular to the top and bottom walls.

9. The air distribution chute mounting system of claim 2, wherein the top wall defines a lifting member receiving opening therethrough that is sized to receive the lifting member and enable the lifting member to extend therethrough.

10. The air distribution chute mounting system of claim 9, further comprising a connecting member, wherein the chute mounting rod is mountable to the guide rod via the connecting member, wherein the lifting member is connectable to the chute mounting rod via connection to the connecting member.

11. A method for mounting an air distribution chute to a trailer having a front wall, a ceiling, and a refrigeration unit partially extending from the front wall into the trailer, the method comprising:
mounting a portion of the air distribution chute to the trailer;
mounting a first mounting bracket to the front wall on a first side of the refrigeration unit;
mounting a second mounting bracket to the front wall on a second side of the refrigeration unit opposite the first side;
mounting a first guide rod to the first mounting bracket and a second guide rod to the second mounting bracket;
mounting a forward end of the air distribution chute to a chute mounting rod;
mounting the chute mounting rod to the first and second guide rods such that the chute mounting rod is movable relative to the first and second guide rods between a lower position in which the air distribution chute is in fluid communication with an air outlet of the refrigeration unit and an upper position in which the chute mounting rod is closer to the ceiling of the trailer than when in the lower position;
operably connecting first and second lifting members to the chute mounting rod; and
moving the chute mounting rod from the lower position to the upper position via the first and second lifting members.

12. The method of claim 11, further comprising removably attaching the first and second lifting members to the trailer to retain the chute mounting rod in the upper position.

13. The method of claim 11, further comprising mounting the portion of the air distribution chute to the ceiling of the trailer.

14. The method of claim 11, further comprising respectively threading the first and second lifting members through lifting member receiving openings defined in top surfaces of the first and second mounting brackets.

15. The method of claim 11, wherein:
mounting the first guide rod to the first mounting bracket comprises extending the first guide rod through one of multiple pairs of guide rod receiving openings defined in the first mounting bracket, and
mounting the second guide rod to the second mounting bracket comprises extending the second guide rod through one of multiple pairs of guide rod receiving openings defined in the second mounting bracket.
